(19) United States
(12) Patent Application Publication
(10) Pub. No.: US 2006/0276240 A1
(43) Pub. Date: Dec. 7, 2006

(54) Crankshaft for a self-propelled agricultural machine

(76) Inventors: Josef Spechtel, Versmold (DE); Egbert Scholz, Bielefeld (DE); Dieter Benten, Sassenberg (DE); Jens Noering, Hoerstel (DE)

Correspondence Address: STRIKER, STRIKER & STENBY, 103 EAST NECK ROAD, HUNTINGTON, NY, 11743, US

(21) Appl. No.: 11/446,078

(22) Filed: Jun. 1, 2006

(30) Foreign Application Priority Data
Jun. 6, 2005 (DE) 10 2005 026 182.5

(51) Int. Cl. A01F 12/30

(52) U.S. Cl. 460/85

(57) ABSTRACT

An offset crankshaft for driving a plurality of adjacently-positioned straw walker racks in a self-propelled agricultural machine, in particular a combine harvester, which includes shaft sections extending in an alternating horizontal and diagonal pattern in the shaft longitudinal direction, each of its horizontal shaft sections passing through a pivot bearing of a straw walker rack, its two shaft ends being rotatably mounted in the combine harvester housing, the crankshaft being statically and dynamically balanced via the variation of the offset angle, by way of which the out-of-balance forces are minimized without the need for additional balancing masses, and by way of which a quiet running behavior of the straw walker crankshaft is attained.

### CROSS-REFERENCE TO A RELATED APPLICATION

The invention described and claimed hereinbelow is also described in German Patent Application DE 10 2005 026 182.5 filed on Jun. 6, 2005. This German Patent Application, whose subject matter is incorporated here by reference, provides the basis for a claim of priority of invention under 35 U.S.C. 119(a)-(d).

### BACKGROUND OF THE INVENTION

The present invention is based, in general, on the field of agriculture and the processing of harvested crops.

Self-propelled agricultural machines designed to pick up and process crops are used for this purpose. The self-propelled agricultural machines are typically threshing machines, in particular combine harvesters, which are equipped with devices for processing the crop material. To process the crop material—which is composed of a mixture of grain material and non-grain components—devices are used, e.g., to separate the different components of the crop material. A device of this type is, e.g., the “straw walker rack”. The straw walker racks are driven by crankshafts on which the straw walker racks are mounted. The crankshaft, which has multiple offsets, is designed to accommodate a plurality of adjacently-positioned straw walker racks, and it is rotatably secured with bearings at at least two points, e.g., in the side panels of the combine harvester housing or the machine frame of the combine harvester. The crankshaft, referred to below as the straw walker crankshaft, includes shaft sections extending in an alternating horizontal and diagonal pattern in the shaft longitudinal direction, each of the horizontal shaft sections serving as a pivot bearing of a straw walker rack and extending through the support of the straw walker rack.

Offset crankshafts used as straw walker crankshafts to drive straw walker racks in combine harvesters are known from the related art. A straw walker crankshaft of this type designed to shake straw walker racks is described in EP 0 069 161 B1. The disadvantage of this design is that an additional bearing is located in the longitudinal mid-plane of the combine harvester, the additional bearing serving to support the straw walker crankshaft. This central steady bearing is required to absorb the vibrations caused by the straw walker crankshaft that result from the mass inequality in the crankshaft and create considerable imbalance. In addition, the offset angles between the offsets are of an order of magnitude that has a disadvantageous effect on the shear strength of the straw walker crankshaft.

The same disadvantages exist with the crankshaft for driving straw walker racks disclosed in DE 39 07 836 C2. In this case as well, the offsets of the crankshaft alternate by 180 degrees. As a result, the adjacently-positioned straw walker racks move in a “push-pull” configuration, which creates imbalance.

A crankshaft with multiple offsets is described in DE 2 018 676, the offsets of the crankshaft being located in different circulatory trajectories and there being only four offsets. The offsets are 180 degrees apart from each other. This configuration is not suitable for use with the six or eight straw walker racks—which extend in parallel with each other—used in modern combine harvesters, the straw walker racks serving the purpose of shaking out the crop material remaining in the straw-chaff mixture and loosening the parts of the straw mat located on the straw walker racks and transporting them with the same rate of motion.

### SUMMARY OF THE INVENTION

The present invention is therefore based on the object of creating an offset straw walker crankshaft of the type described initially that prevents the aforementioned disadvantages of the known related art, and to provide a technical solution that makes it possible to manufacture an offset straw walker crankshaft having a simple functional geometry and a design capable of being used with a large number of straw walker racks.

In keeping with these objects and with others which will become apparent hereinafter, one feature of the present invention resides, briefly stated, in an offset crankshaft for driving a plurality of adjacently-positioned straw walker racks in a self-propelled agricultural machine, comprising shaft sections extending in an alternating horizontal and diagonal pattern in a shaft longitudinal direction so that each of said horizontal shaft sections pass through a pivot bearing of a straw walker rack; two shafts ends rotatably mounted in an agricultural machine housing, wherein the crankshaft is configured so that it is statistically and dynamically balanced via a variation of an offset angle.

To create an offset straw walker crankshaft—having the features of the present invention—for straw walker racks of combine harvesters, it is provided according to the present invention to manufacture an offset straw walker crankshaft that has optimum static and dynamic mass balance values in order to prevent imbalance—and, therefore, destructive vibrations—from forming at high rotational speeds, and to make it possible to eliminate the central steady bearing typically used with long straw walker crankshafts without having to enlarge the cross section of the straw walker crankshaft.

Static imbalance results when the axis of rotation of the straw walker crankshaft does not extend through the centroid axis. Static imbalance is characterized by the fact that the plane in which the imbalance is located coincides with the radial plane of the centroid axis. Static imbalance is a special case of dynamic imbalance. Dynamic imbalance arises when the axis of rotation of the straw walker crankshaft is different from the main axis of inertia of the straw walker crankshaft. The axis of rotation then tilts into the centroid axis. Dynamic imbalance occurs only during operation. It is expressed as a bending moment, i.e., the unbalance moment, on the axis of rotation and also acts on the roll axis of the straw walker racks. The roll axis extends in the longitudinal direction of the combine harvester and in parallel with the straw walker racks. Further explanations of this are provided in the descriptions of FIGS. 1 through 3.

A further criterium is the robustness of the straw walker crankshaft, which is determined by the material and cross section in the case of crankshafts that are forged, cast or bent as single components. To design a straw walker crankshaft with optimum robustness, the dimensions must not be too weak or strong, to prevent ruptures in the straw walker crankshaft caused by resonance vibrations in the critical rotational speed range. For this reason, it is not possible to easily design relatively long straw walker crankshafts with a correspondingly greater amount of strength.

The offset crankshaft acted upon very strongly by resonance vibrations and impacts should be capable of shaking the straw walker racks and operating quietly when crop material throughput is high.

A mass-balanced crankshaft is used that allows the bearing forces in the bearings to nearly vanish at any time. As a result, the sum of the bearing forces is a minimum. To accomplish this, the straw walker crankshaft must fulfill kinetic conditions that result from the static and dynamic imbalance and that are met, according to the present invention, by varying the offset angle between the offsets, all of the offsets having the same crank throw.

An advantageous embodiment of the present invention results when the offset angle between two adjacent offsets is at least 90 degrees, so that a shaking effect of the crop material can be produced on the straw walker racks. According to the present invention, in an optimum sequence of offsets for the shaft sections positioned horizontally in the longitudinal shaft direction, the offset angle is between 110 degrees and 160 degrees, with an optimum value for the succession of offsets, i.e., a sequence of offset angles of approximately 120 degrees and approximately 140 degrees, preferably resulting for a straw walker crankshaft with six offsets. That is, adjacently-positioned offsets do not alternate by 180 degrees, as in the related art. Instead, the masses of the horizontal shaft sections are positioned around the circumference such that they are mass-balanced via the different offset angles.

By varying the offset angles of the straw walker crankshaft, the out-of-balance forces caused by the straw walker crankshaft and the straw walker racks are reduced around the axis of rotation of the straw walker crankshaft and around the roll axis of the combine harvester. As a result, the vibrations of the combine harvester and the stress on the bearings of the straw walker crankshaft in the machine housing are greatly reduced.

The variation of the offset angles according to the present invention is not limited to the straw walker crankshaft with six offsets shown in the figures. Instead, it can be used on straw walker crankshafts having any number of offsets and/or straw walker racks.

The sequence of the offset angles for a straw walker crankshaft with eight offsets positioned at the same circle diameter nearly corresponds to the sequence of offsets used for a straw walker crankshaft with six offsets. That is, the offset angle between two adjacent offsets is at least 90 degrees and less than 180 degrees, and preferably 150 degrees. As a result of the mass-balanced distribution of offsets—according to the present invention—on a circle diameter with consideration for the eccentricity, i.e., the minimization of the eccentricity of the axes of symmetry of the offsets with respect to the axis of symmetry and/or axis of rotation of the shaft ends (bearing points) of the straw walker crankshaft, the known balancing procedure—which is very time and labor-intensive—is no longer required.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a self-propelled agricultural machine with straw walker racks,

FIG. 2 is a schematic front view of a straw walker crankshaft with a plurality of adjacently-positioned straw walker racks and two shaft bearings on the ends,

FIG. 3 is a sketch of a side view of an offset straw walker crankshaft.

### DESCRIPTION OF THE PREFERRED EMBODIMENTS

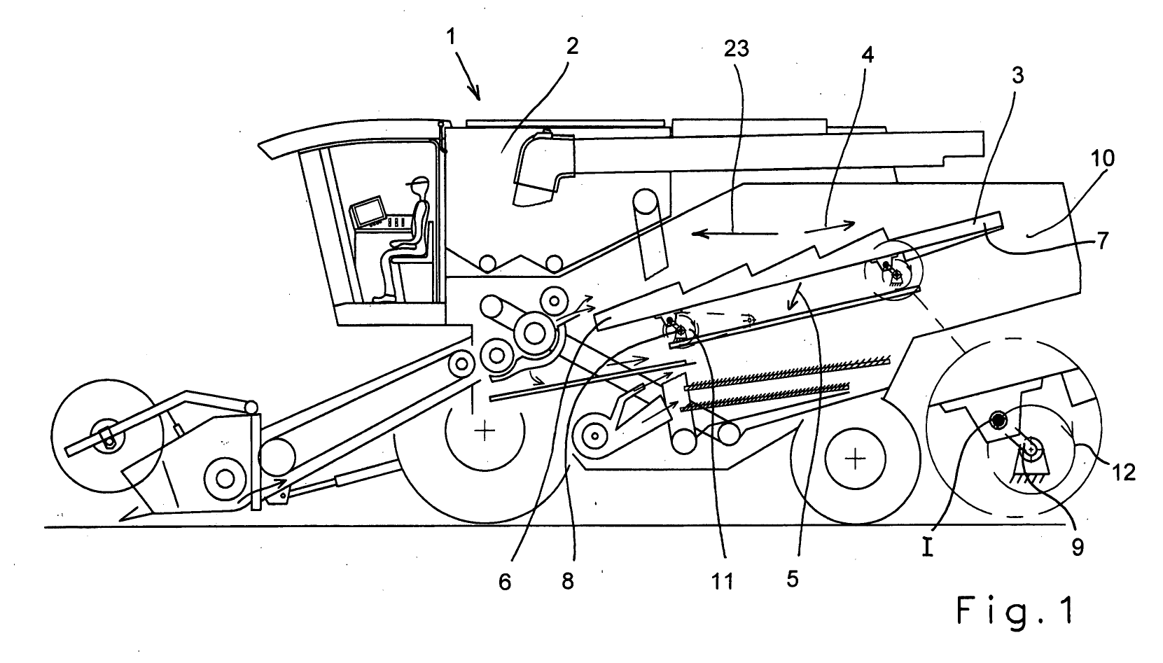

According to FIG. 1, the present invention relates to a self-propelled agricultural machine 1, in particular a combine harvester 2, to the rear region of which straw walker racks are assigned, the straw walker racks separating out grain 5 which remains in straw-chaff mixture 4. Straw walker racks 3 are rotatably mounted in front region 6 and rear region 7 on straw walker crankshafts 8, 9 and/or in machine housing 10 of combine harvester 2.

At least one of the straw walker crankshafts 8, 9 is rotatably driven in the clockwise direction, e.g., by a pulley 11. Straw walker racks 3, which are hingedly connected with straw walker crankshafts 8, 9, each move alternately up and down and back and forth on a circulatory trajectory 12, by way of which straw-chaff mixture 4 is conveyed via straw walker racks 3 into the rear region of combine harvester 2.

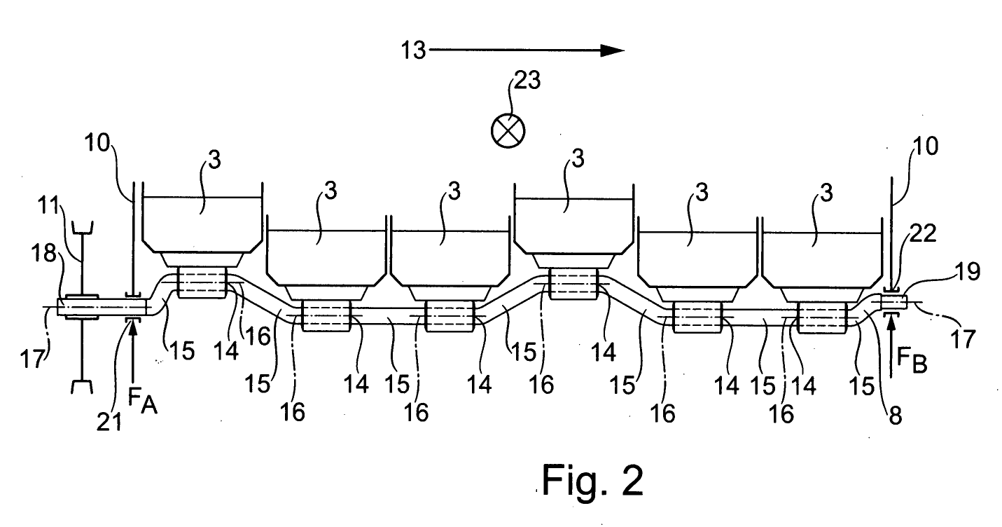

FIG. 2 shows a schematic front view of a straw walker crankshaft 8 according to the present invention, with shaft 8 and six straw walker racks 3 mounted thereon supported in a combine harvester housing 10. Straw walker crankshaft 8 is designed as a single component and has offsets. Shaft sections 14, 15 extend in an alternating horizontal and diagonal pattern in shaft longitudinal direction 13. With its horizontal shaft sections 14, the axis of symmetry 16 of which extends in parallel with the axis of rotation 17 of shaft ends 18, 19, straw walker crankshaft 8 passes through each pivot bearing 20 of a straw walker rack 3.

Straw walker crankshaft 8 is rotatably mounted with its two coaxial and horizontally extending shaft ends 18, 19 in outer bearings 21, 22, preferably radial bearings, in combine harvester machine frame 10. A pulley 11 is attached, e.g., at one shaft end 18, to rotate straw walker crankshaft 8.

When straw walker crankshaft 8 rotates around axis of rotation 17—horizontal shaft ends 14 being located equidistantly from the axis of rotation and straw walker racks 3 mounted thereon—out-of-balance forces are normally produced, which, in turn, result in supporting reactions (F_{A}, F_{B}). These supporting reactions (F_{A}, F_{B}) place considerable stress on the external bearings 21, 22 of straw walker crankshaft 8 in machine housing 10 and cause combine harvester 2 to sway around a roll axis 23 (FIG. 2) extending in the longitudinal direction of combine harvester 2, the variation of offset angles 24-28 causing supporting reactions F_{A}, F_{B} to nearly vanish in every position of straw walker crankshaft 8.

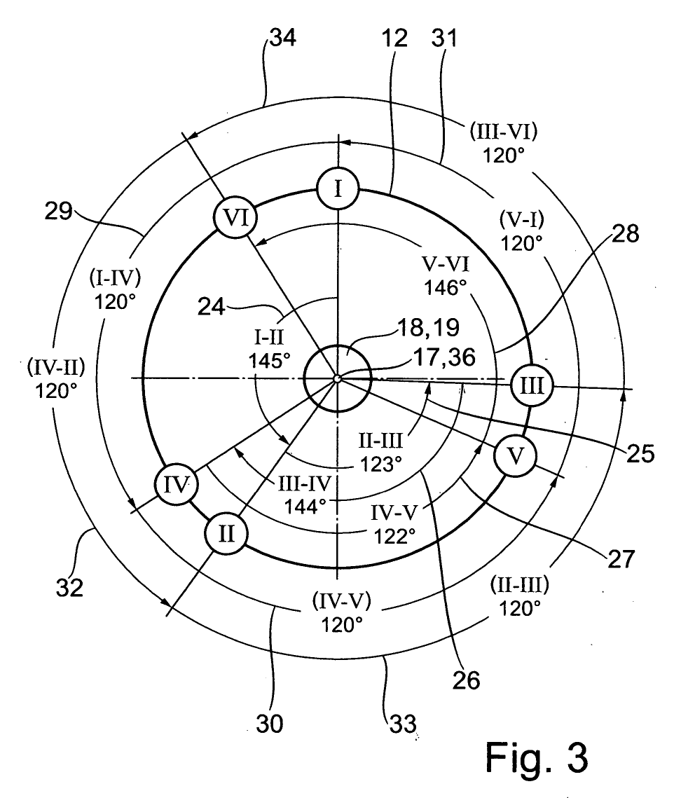

FIG. 3 shows how straw walker crankshaft 8, 9 is composed of a plurality of offsets I-VI, offsets I-VI each having the same crank throw and the same circular trajectory 12, and straw walker racks 3 each being supported in the center in the corresponding offset I-VI (see FIG. 2, 20). Offset angles 24-28 between offsets I-VI vary according to the present invention and, as a result, are of different sizes. That is, adjacently-positioned offsets I-VI do not alternate by 180 degrees, as in the related art. Instead, horizontal shaft sections 14 of offsets I-VI are distributed in a mass-balanced manner on a circumference 12 at an angular distance 29-34 of approximately 120 degrees. This means angular distance 29 between offsets I and IV, angular distance 30 between offsets IV-V, angular distance 31 between offsets V and I, angular distance 32 off offsets VI and II, angular distance 33 between offsets II and III, and angular distance 34 between offsets III and IV are all approximately 120 degrees.

As a result, in the sequence of offset angles according to the present invention, an offset angle greater than 90 degrees and less than 180 degrees results between two adjacent offsets. The exact sequence of offsets 24-28 is shown in FIG. 3. The offsets alternate by approximately 120 degrees or approximately 140 degrees. As a result of the arrangement, according to the present invention, of the sequence of offset angles 24-28 between the offsets, straw walker crankshaft 8, 9 is statically and dynamically balanced. That is, the number of centers of rotation of axes of symmetry 16 (see FIG. 2) that result from the number of offsets I-VI and that are located on circulatory trajectory 12 form a centroid axis 36. This centroid axis 36 coincides with axis of rotation 17 due to the sequence of offset angles according to the present invention.

The principle of an embodiment of a straw walker crankshaft 8, 9 shown in FIG. 3 is not limited to a certain number of offsets. Instead, it can be used with any number of offsets, be it an even number or an uneven number.

It will be understood that each of the elements described above, or two or more together, may also find a useful application in other types of constructions differing from the types described above.

While the invention has been illustrated and described as embodied in a crankshaft for a self-propelled agricultural machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An offset crankshaft for driving a plurality of adjacently-positioned straw walker racks in a self-propelled agricultural machine, comprising shaft sections extending in an alternating horizontal and diagonal pattern in a shaft longitudinal direction so that each of said horizontal shaft sections pass through a pivot bearing of a straw walker rack; two shaft ends rotatably mounted in an agricultural machine housing, wherein the crankshaft is configured so that it is statistically and dynamically balanced via a variation of an offset angle.

2. An offset crankshaft as defined in claim 1; and further comprising means for supporting the crankshaft in external bearings in the agricultural machine housing.

3. An offset crankshaft as defined in claim 1, wherein the crankshaft is configured so as to produce out-of-balance forces which in turn result in supporting reactions in external bearings, which supporting reactions nearly vanish in every position of the crankshaft due to the variation of the offset angle.

4. An offset crankshaft as defined in claim 1, wherein the crankshaft is configured so that a compensation for out-of-balance forces of the crankshaft takes place around an axis of rotation and around a roll axis of the agricultural machine.

5. An offset crankshaft as defined in claim 1, wherein said offset angle of two adjacent offsets is greater than 90° and less than 180°.

6. An offset crankshaft as defined in claim 1, wherein the crankshaft has offsets distributed around a circumference at an angular distance that alternates between approximately 120° and approximately 140°.

7. An offset crankshaft as defined in claim 1; and further comprising a horizontal shaft section and adjacent diagonal shaft sections, arranged so that said horizontal shaft section together with said adjacent diagonal shaft sections form an offset.

8. An offset crankshaft as defined in claim 1; and further comprising means provided for rotation of the crankshaft around an axis of rotation, and offsets have a constant crank throw.
